(19) United States
(12) Patent Application Publication
(10) Pub. No.: US 2025/0320158 A1
(43) Pub. Date: Oct. 16, 2025

(54) STRENGTH ENHANCING ADMIXTURE FOR CEMENTITIOUS COMPOSITIONS

(71) Applicant: ZYMIX INC., Las Vegas, NV (US)

(72) Inventors: Ori Botensky, Las Vegas, NV (US); Gino Pereira, Las Vegas, NV (US); Nir Dror, Tel Aviv (IL)

(21) Appl. No.: 19/176,795

(22) Filed: Apr. 11, 2025

Related U.S. Application Data
(60) Provisional application No. 63/633,254, filed on Apr. 12, 2024.

(51) Int. Cl. C04B 24/10; C04B 22/08; C04B 24/06; C04B 24/12; C04B 103/12

(52) U.S. Cl. CPC C04B 24/10; C04B 22/085; C04B 24/06; C04B 24/126; C04B 2103/12

(57) ABSTRACT

An organic strength enhancing admixture composition that increases the compressive strength of cementitious compositions without negatively affecting the workability. The admixture comprises water soluble chemicals that control the rate of hydration of cement to allow less cement to be used in a comparable concrete mix design to achieve an equivalent strength.

### CROSS-REFERENCE OT RELATED APPLICATION

This application claims the benefit of priority to U.S. Provisional Patent Application No. 63/633,254 filed Apr. 12, 2024, the disclosure of which is incorporated herein by reference in its entirety.

### FIELD

The disclosure relates to an additive for concrete compositions and uses thereof in producing concrete compositions with improved compressive strength.

### BACKGROUND

As a basic structural material for most of the world's buildings, bridges, roads and dams, concrete releases an extreme amount CO₂ each year. It is the highest consumed product on earth besides water. Until the overall emissions are cut worldwide, the environment will continue to be polluted with over 4 billion tons of carbon dioxide annually due to the construction industry.

Concrete is constructed using cement mixed with an aggregate, a grainy blend of materials such as stone and sand and potentially a pozzolan, such as fly ash. After mixing, the concrete is poured and left to harden. The aggregates are sourced locally and crushed in a procedure familiar to those skilled in the process. That process releases hardly any carbon emissions. Cement is the true problem when it comes to a carbon footprint. The cement process is sole reason the concrete industry makes up 8% of overall global emissions.

Portland cement is the basic ingredient of concrete. Concrete is formed when Portland cement creates a paste with water that binds with sand and rock to solidify.

Cement is manufactured through a tightly controlled chemical combination of calcium, silicon, aluminum, iron, and other ingredients.

Common materials used to manufacture cement include limestone, shells, and chalk combined with shale, clay, slate, blast furnace slag, silica sand, and iron ore. These ingredients, when heated at high temperatures, form a rock-like substance that is ground into the fine powder that we commonly think of as cement.

The 2015 Paris Agreement on Climate Change, which the United States rejoined in 2021, sets as a goal that CO₂ emissions need to fall by 15% by 2030. As the second largest producer of CO₂ on the planet there is an urgent need for a less pollutive form of concrete. One possible solution is the reduction of cement content in concrete. Every pound of cement saved in concrete reduces CO₂ emission by 0.9 pounds.

Cement prices have also increased significantly in the last few years with expected price increases in 2022 alone to exceed 7%. Much of this is due to increased demand which is expected to continue further exacerbating the CO₂ problem. Due to increased demand, there is also a shortage of cement supply with many producers unable to purchase the amounts that they require to satisfy demand. Furthermore, the increase in shipping and logistics costs over the last few years has significantly further increased the cost of cement. There is a need to control these rising prices and one solution is to reduce the amount of cement in the production of concrete as it accounts for approximately 75% of the material cost of concrete and 8% of global carbon dioxide emissions.

To date, commercially available solutions have been unable to achieve a reduction of CO₂ emissions from concrete in an amount that approaches or exceeds the 15% reduction requirement in the Paris Accord and reduces the overall cost of concrete production.

### SUMMARY

An additive in accordance with the disclosure when added to cement, produces a significant gain in the compressive strength of concrete and reduces the required quantity of cement. The additive can be diluted with water and added to the concrete mix at the same time as the appropriate amount of water is added to the concrete mix design. The concrete mix design is any design that complies with ACI 211. 1-91 or ACI 211.2-98 or ASTM C595 or AASHTO M 240 Standard Specification for Blended Hydraulic Cements Thus, the inclusion of this combination requires no additional procedures outside of the normal concrete manufacturing process. The combination can be used in combination with other cement additives such as setting accelerators, air entraining agents, cement swelling and dispersing agents, water proofing agents, strength enhancing agents and water reducing agents. Cements customarily used for preparing concrete and mortar, such as Portland cement, type 1L cement, blast furnace cement, silica cement, alumina cement, diatomaceous earth cement, slag cement, shale ash cement and others, can be used as the cement in the present invention.

When the combination is applied to an appropriate mix design, it was observed that an increase in the compressive strength of approximately 20%. As a result of this, mix designs with less cement can be used to achieve desired compressive strength, resulting in a reduction of CO₂ emissions and a reduction the overall cost of concrete raw materials.

### DETAILED DESCRIPTION

An additive for concrete in accordance with the disclosure can include a disaccharide, a carbamide, and a tricarboxylic acid. It was observed that the additive of the disclosure including a disaccharide, a carbamide, and a tricarboxylic acid can slow the setting time of concrete. This can be advantageous in various situations and can enhance ultimate strength. It was further observed that the retardant effect of the additive can be reduced by further including a concrete setting accelerator as part of the additive or as a separate addition of the additive. The resulting combination can advantageously allow for faster setting times while retaining the long-term strength enhancement provided by the additive's underlying retardant effect of the disaccharide, carbamide, and tricarboxylic acid.

A concrete composition prepared with the additive of the disclosure was observed to have increased compressive strength as compared to a concrete composition without the additive. The concrete composition to which the additive is added can include cement, water, coarse and/or fine aggregates. Concrete compositions suitable for use with the additives of the disclosure include those as specified in ACI 211. 1-91 or ACI 211.2-98 or ASTM C595 or AASHTO M 240 Standard Specification for Blended Hydraulic Cements and can optionally further include at least one pozzolan, such as fly ash and/or accelerating admixture.

The additive of the disclosure can be added to a concrete composition in an amount of about 0.25 fl. oz. to about 6 fl. oz. per hundredweight of cementitious material. The additive and the concrete composition can be mixed using any known mixing methods.

An additive in accordance with the disclosure can include, for example, about 10 wt % to about 60 wt % disaccharide, about 5 wt % to about 30 wt % carbamide, and about 5 wt % to about 25 wt % tricarboxylic acid, based on the weight of the additive.

The disaccharide can include one or more of sucrose, maltose, and molasses.

The carbamide can include one or both of urea and ethyl carbonate.

The tricarboxylic acid can include one or more of citric acid, isocitric acid, and aconitic acid.

The additive can optionally further include a concrete setting accelerator. The concrete setting accelerator can be a nitrate, for example. For example, the concrete setting accelerator can be calcium and/or potassium nitrate. In addition, formates, alkanolamines and/or thiocyanate salts may be used. The additive composition can include 2-6 parts accelerator to 1 part of the combination of disaccharide, tricarboxylic acid, and carbamide.

Alternatively, an accelerator can be optionally added to the concrete composition as a separate component from the additive.

The additive can be made by admixing the components with water. The water can be, for example, about 10% to about 50% by weight of the composition.

The additive can be added to the dry concrete mix at the same time as the water is added for forming the mix into the concrete mix design. The concrete mix design is any design that complies with ACI 211. 1-91 or ACI 211.2-98 or ASTM C595. Use of the additive of the disclosure advantageously requires no additional procedures outside of the normal concrete manufacturing process.

The additive of the disclosure can be used in combination with other cement additives such as, but not limited to, setting additives, air entraining agents, cement swelling and dispersing agents, water proofing agents, strength enhancing agents and water reducing agents.

The additive of the disclosure can be used with a variety of cement types. For example, the additive can be used with cements customarily used for preparing concrete and mortar, such as Portland cement, type 1L cement, blast furnace cement, silica cement, alumina cement, diatomaceous earth cement, slag cement, shale ash cement and others.

In accordance with the disclosure a concrete composition can include cement and the additive, and optionally one or more of, a pozzolan, setting additives, air entraining agents, cement swelling and dispersing agents, water proofing agents, strength enhancing agents and water reducing agents, water, coarse aggregate, and fine aggregate.

The cement can include Portland cement, type 1L limestone cement, blast furnace cement, silica cement, alumina cement, diatomaceous earth cement, slag cement, shale ash cement and other types of cement.

The pozzolan can be siliceous or siliceous and aluminous material, which in itself possesses little or no cementitious value but which will, in finely divided form and in the presence of moisture, chemically react with calcium hydroxide at ordinary temperature to form compounds possessing cementitious properties such as, but not exclusively, fly ash and silica fume.

The concrete composition may include setting additives, air entraining agents, cement swelling and dispersing agents, water proofing agents, strength enhancing agents, water reducing agents, and other agents having these characteristics.

### EXAMPLES

The following examples demonstrate the compressive strength increase achieved by adding the additive of the disclosure. Control compositions of concrete were prepared as identified in table 1. The compositions in accordance with the disclosure we prepared by adding the additive of the disclosure to the control concrete compositions. The additive composition used in Examples 1 and 2 is provided in Table 2.

TABLE 1
Concrete Compositions

| | | Control 1 | Control 2 | Example 1 | Example 2 |
|---|---|---|---|---|---|
| Water/cement ratio | | 0.57 | 0.57 | 0.57 | 0.57 |
| Concrete | Cement (lbs) | 700 | 540 | 700 | 540 |
| Composition | Sand (lbs) | 1700 | 1880 | 1700 | 1880 |
| | Stone (lbs) | −2300 | 2100 | −2300 | 2100 |
| | Total | 4700 | 4520 | 4700 | 4520 |

| | | | |
|---|---|---|---|
| Additive in accordance with the | — | 4.3 fl oz/cwt | 3.5 fl oz/cwt |
| disclosure (Formulation in Table | | cementitious | cementitious |
| 2) | | material | material |

TABLE 2
Additive Composition by weight of the Additive

| | | |
|---|---|---|
| Disaccharide, | 70-85 | wt % |
| Carbamide, | 10-20 | wt % |
| Tricarboxylic acid | 5-10 | wt % |

The compressive strength of the compositions was tested in accordance with ASTM C39 after 7 days of curing and after 28 days of curing. Examples 1 and 2 including the additive demonstrated significantly improvement in compressive strength.

TABLE 3
Compressive Strength Results

Compressive Strength (PSI)

| | 7 Days | 28 Days |
|---|---|---|
| Control 1-Design | 4785 | 6450 |
| Strength 4600 psi | | |
| Example 1 | 5300 | 6820 |
| Control 2-Design | 2900 | 3625 |
| Strength 2900 psi | | |
| Example 2 | 4280 | 5584 |

A comparison of Example 2 to Control 2 illustrates that the additive provided for improved compressive strength, with an increase of 54% in compressive strength. It was further observed that design strength could be achieved when using an additive in accordance with the disclosure with significantly lower amount of cement being needed to achieve a desired design strength. In particular, Example 2 was able to achieve a compressive strength that satisfied a design strength of 4600 PSI, while having about 23% less cement content than Control 1, which is a conventional formulation for achieving such a design strength. Such an increase in compressive strength would not have been expected with the significant reduction of cement used in Example 2 as compared to Control 1. It is generally understood in the art that compressive strength of a concrete composition decreases with decreased cement content. These examples show that the additive is an effective replacement for cement by approximately 20%.

A further additive in accordance with the disclosure was tested. The additive further included calcium nitrate.

TABLE 4
Material composition for ASTM C494 S compliance testing

| | | | Control 3 | Example 3 |
|---|---|---|---|---|
| Water/cement ratio | | | 0.51 | 0.50 |
| | Concrete | Cement (lbs) | 57 | 57 |
| | Composition | Sand (lbs) | 133 | 141 |
| | | Stone (lbs) | 212 | 212 |
| | | Total | 402 | 410 |

| | | |
|---|---|---|
| Additive in accordance with the | — | 13 fl oz/cwt |
| disclosure (formulation in Table | | cementitious |
| 5) | | material |

TABLE 5
Additive Composition by weight of the Additive

| | | |
|---|---|---|
| Disaccharide | 15-50 | wt % |
| Carbamide | 2-10 | wt % |
| Tricarboxylic acid | 1-5 | wt % |
| Calcium nitrate | 50-85 | wt % |

TABLE 6
Compressive Strength Results

Compressive Strength (PSI)

| | 7 Days | 28 Days |
|---|---|---|
| Control 3-Design | 4170 | 5530 |
| Strength | | |
| 4000 psi | | |
| Example 3 | 5140 | 7150 |

It was surprisingly found that the inclusion of calcium nitrate in the additive offset some of the setting retardant effect of the additive, without sacrificing the increase in long term compressive strength achieved when the additive in accordance with the disclosure was included. On its own, calcium nitrate is known in the art to increase early compressive strength and setting times at the expense of weaker long-term strength. As with Examples 1 and 2, Example 3 achieved a significant increase in compressive strength over the control having no additive and maintained the improvement in long-term strength.

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A strength enhancing additive for cement, comprising:
about 10 wt % to about 60 wt % of a disaccharide;
about 5 wt % to about 30 wt % of a carbamide;
about 5 wt % to about 25 wt % of a tricarboxylic acid, wherein the weight percentages are all based on the total weight of the additive.

2. The additive of claim 1, wherein the disaccharide comprises one or more of sucrose, maltose, and molasses.

3. The additive of claim 1, wherein the carbamide comprises urea and/or ethyl carbonate.

4. The additive of claim 1, wherein the tricarboxylic acid comprises one or more of citric acid, isocitric acid, and aconitic acid.

5. The additive of claim 1, further comprising a concrete setting accelerator.

6. The additive of claim 5, wherein the concrete setting accelerator is present in an amount of about 50 wt % to about 85 wt % based on the total weight of the additive.

7. The additive of claim 5, wherein the concrete setting accelerator comprises a nitrate.

8. The additive of claim 7, wherein the additive is calcium nitrate and/or potassium nitrate.

9. The additive of claim 5, wherein the concrete setting accelerator comprises one or more of formats, alkanolamines, and thicyanate salts.

10. The additive of claim 5, wherein the additive comprises 2 to 6 parts accelerator to 1 part of a combination of the disaccharide, tricarboxylic acid, and carbamide.

11. The additive of claim 1, wherein the disaccharide is present in an amount of about 15 wt % to about 50 wt % based on the total weight of the additive.

12. The additive of claim 1, wherein the carbamide is present in an amount of about 2 wt % to about 10 wt % based on the total weight of the additive.

13. The additive of claim 1, wherein the tricarboxylic acid is present in an amount of about 1 wt % to about 5 wt % based on the total weight of the composition.

14. A method of making concrete, comprising admixing the additive of claim 1, dry concrete mix, and water.

15. The method of claim 14, wherein the additive replaces at least 20% of the dry concrete mix.

16. The method of claim 14, wherein the concrete comprises the additive in an amount of 3.5 to 4.3 fl oz per cwt of dry concrete mix.
